(19) United States
(12) Patent Application Publication
(10) Pub. No.: US 2006/0082592 A1
(43) Pub. Date: Apr. 20, 2006

(54) Mapping of a color to a treemap

(75) Inventors: Elizabeth Ann Black-Ziegelbein, Austin, TX (US); Gennaro A. Cuomo, Cary, NC (US); Marc E. Haberkorn, Raleigh, NC (US); Barton C. Vashaw, Apex, NC (US)

Correspondence Address: A. Bruce Clay;IBM Corporation, T81/503, 3039 Cornwallis Road, Research Triangle Park, NC, 27709, US

(73) Assignee: International Business Machines Corporation, Armonk, NY (US)

(21) Appl. No.: 10/968,235

(22) Filed: Oct. 19, 2004

(51) Int. Cl. G09G 5/02

(52) U.S. Cl. 345/605

(57) ABSTRACT

The inventive process comprises and improved process for displaying hierarchical information in a treemap by associating a different color with each nested treemap in a parent treemap, and generating a gradient for each color to preserve the representative value of varying shades. In general, a user divides the hierarchical information into clusters of nodes, designates a primary weight and a secondary weight for each cluster, and designates a base color for each cluster. The inventive process then divides the range of each cluster's secondary weight into bins, adjusts each cluster's base color to create a distinguishing gradient of the base color, assigns a distinguishing gradient to each bin, and draws a nested treemap for each cluster so that each nested treemap has a cluster's base color and each node in the cluster is represented by a bounding box having a distinct gradient of the cluster's base color.

### FIELD OF THE INVENTION

The present invention relates generally to processing data for visual presentation, wherein the processing includes the creation or manipulation of graphic objects prior to presenting the processed data on a specific display system. More particularly, the present invention includes subject matter wherein the processed data is displayed to a user as one or more nested treemaps showing a relationship between two or more variables. The present invention further includes color information processing wherein the color and shading in the treemap is calculated to visually distinguish a nested treemap from the parent treemap or other nested treemaps.

### BACKGROUND OF THE INVENTION

Conceptually, much of the world's information can be organized as a hierarchy. Brian Johnson & Ben Shneiderman, Tree-Maps: A Space-Filling Approach to the Visualization of Hierarchical Information Structures (April 1991), at ftp://ftp.cs.umd.edu/pub/hcil/Reports-Abstracts-Bibliography/91-06html/91-06.html (last visited Oct. 8, 2004) (incorporated herein by reference). For many years, the most common methods for presenting hierarchical information were listings, outlines, and tree diagrams. Id. A tree diagram is a widely-used computer data structure that emulates a tree structure with a set of linked “nodes.” As used herein, the term “node” includes any data structure unit having either data or a link to another data structure unit. Each node may have one or more “child nodes,” which are below it in the tree. Naturally, the node of which a node is a child is called its “parent node.” A child node has at most one parent node. A child node without a parent node is called the “root node.” Generally, a tree diagram has only one root node. A node having only data and no child node is called a “leaf node,” while any node that is neither a root node nor a child node is referred to generally as an “interior” node. See, generally, Wikipedia, at http://en.wikipedia.org/wiki/Tree data structure (last visited Oct. 13, 2004) (incorporated herein by reference); Ben Shneiderman, Tree visualization with Tree-maps: A 2-D space filling approach (Jun. 18, 1991), ftp://ftp.cs.umd.edu/pub/hcil/Reports-Abstracts-Bibliography/91-03html/91-03.html (last visited Oct. 8, 2004) (incorporated herein by reference) [hereinafter Shneiderman I]. The amount of space required to display listings, outlines, and tree diagrams, though, is directly proportional to the amount of information displayed. Thus, the conventional rooted display methods generally make poor use of display space or hide vast amounts of information from users. See Johnson & Shneiderman, supra.

“Treemaps” first appeared in the early 1990's as an alternative to the conventional presentation methods. See, e.g., Ben Shneiderman, Treemaps for space-constrained visualization of hierarchies (Dec. 26, 1998), at http://www.cs.umd.edu/hcil/treemap-history/ (last updated May 18, 2004) (last visited Oct. 8, 2004) (incorporated herein by reference) [hereinafter Shneiderman II]; Shneiderman I, supra; Johnson & Shneiderman, supra. A treemap “makes 100% use of the available display space, mapping the full hierarchy onto a rectangular region in a space-filling manner. This efficient use of space allows very large hierarchies to be displayed in their entirety and facilitates the presentation of semantic information.” Johnson & Shneiderman, supra. As Johnson & Shneiderman explain, treemaps “partition the display space into a collection of rectangular bounding boxes representing the tree structure. The drawing of nodes within their bounding boxes is entirely dependent on the content of the nodes, and can be interactively controlled. Since the display size is user controlled, the drawing size of each node varies inversely with the size of the tree (i.e., # of nodes). Trees with many nodes (1000 or more) can be displayed and manipulated in a fixed display space.” Id. Thus, treemaps provide access to detail while keeping the global context. Harsha Kumar et al., Visual Information Management for Network Configuration (June 1994), at ftp://ftp.cs.umd.edu/pub/hcil/Reports-Abstracts-Bibliography/94-07html/94-07.html (last visited Oct. 8, 2004). Screen space utilization is maximized, and scrolling and panning are not required. Id. The number of nodes that can be displayed in a treemap is an order of magnitude greater than that by a traditional tree diagram. Id.

Originally developed to visualize large directory structures on a hard disk, see Shneiderman I, supra; Johnson & Shneiderman, supra, treemaps have evolved considerably, and now include rich feature sets that support flexible hierarchies, color binning, improved color setting, and aggregation. Shneiderman I, supra. Several treemap variants also have evolved to address some of the shortcomings of the original implementation. Two popular variants are the “nested” (or “clustered”) and “squarified” treemap, both of which employ an algorithm for minimizing aspect ratios of each bounding box displayed in a treemap. See, e.g., Benjamin B. Bederson et al., Ordered and Quantum Treemaps: Making Effective Use of 2D Space to Display Hierarchies (October 2002), at ftp://ftp.cs.umd.edu/pub/hcil/Reports-Abstracts-Bibliography/2001-18html/2001-18.pdf (last visited Oct. 8, 2004) (incorporated herein by reference). Treemaps have been used to provide an efficient visual presentation of a diverse variety of information, ranging from financial analysis to sports reporting. Id. See also Shneiderman I, supra; Map of the Market, http://www.smartmoney.com/marketmap (last visited Oct. 13, 2004). In an enterprise computing system, system administrators also need to monitor large collections of data about the performance of an entire network topology. Much like tree data structures, a network topology generally consists of a root node and one or more linked nodes. Thus, treemaps are ideal for depicting network performance data. Typically, such performance data consists of five to ten properties (such as central processing unit (CPU) usage, goal attainment, name, and number of deployed applications) for each node in the topology. The number of nodes in any given topology can vary, but the number typically ranges from ten to one thousand. FIG. 1 is a nested treemap of an exemplary network topology comprised of twenty-three network nodes. As described above, the illustrative treemap in FIG. 1 partitions the display space into rectangular bounding boxes, so that each node in the network is represented by a corresponding rectangular bounding box 10. As used herein, a “bounding box” refers to any rectangular box that circumscribes an area in a treemap that is proportional to the value of one property of the nodes displayed in the treemap. Thus, in FIG. 1, the treemap is partitioned into twenty-three bounding boxes, and the area of each bounding box is proportional to one property of each network node. The treemap in FIG. 1 also illustrates the concept of nested treemaps. In FIG. 1, seven nodes have been grouped together as a “cluster” and displayed as nested treemap “WebGroup,” and another six nodes have been clustered together and displayed as a second nested treemap designated as “Cluster A.”

Hierarchical information comprises both structural (also referred to as “organizational”) information associated with the hierarchy, and content information associated with each node in the hierarchy. Johnson & Shneiderman, supra. Generally, treemaps rely heavily on visual cues such as color and size to present content information to a user. Id. A color gradient often represents a given property of a given node, while bounding box size represents another property of the node. Thus, in the treemap of the exemplary network topology of FIG. 1, the shading of each bounding box might represent each node's CPU usage, while the area of each bounding box might be proportional to the number of applications deployed on each node. Or, if a treemap represents stock market data, a color gradient from red to black to green might represent a particular stock's performance for a given day, while box size might represent trading volume. Related nodes, such as stocks within a particular sector, often are grouped together and displayed in a nested treemap within a parent treemap. Conventional nested treemaps, though, do little to visually differentiate nested treemaps from each other.

The invention described in detail below addresses this shortcoming in the art. In particular, it is an object of the present invention to improve processing of color information and shading in a treemap so that a nested treemap is visually distinguishable from a parent treemap or other nested treemaps. This and other objects of the invention will be apparent to those skilled in the art from the following detailed description of a preferred embodiment of the invention.

### SUMMARY OF THE INVENTION

The inventive process described below comprises an improved process for displaying hierarchical information in a treemap by associating a different color with each nested treemap in a parent treemap, and generating a gradient for each color to preserve the representative value of varying shades.

In general, a system administrator or other user divides the hierarchical information into clusters of nodes, designates a primary weight and a secondary weight for each cluster, and designates a base color for each cluster. The inventive process comprises dividing the range of each cluster's secondary weight into bins, adjusting each cluster's base color to create a distinguishing gradient of the base color, assigning a distinguishing gradient to each bin, and drawing a nested treemap for each cluster so that each nested treemap has the cluster's base color and each node in the cluster is represented by a bounding box having a distinct gradient of the cluster's base color.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is a treemap of an exemplary network topology;

FIG. 2 depicts an exemplary network of prior art hardware devices;

FIG. 3 is a schematic of a computer memory in which the present invention resides;

FIG. 4 illustrates the inventive process of mapping a color to a treemap;

FIG. 5 illustrates a JAVA implementation of generating gradient waypoints;

FIG. 6 illustrates a JAVA implementation of generating color gradients for a range of secondary weights; and

FIG. 7 illustrates a JAVA implementation of generating a color gradient that is proportional to two bounding colors.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to below as the “TreeMap Program.”

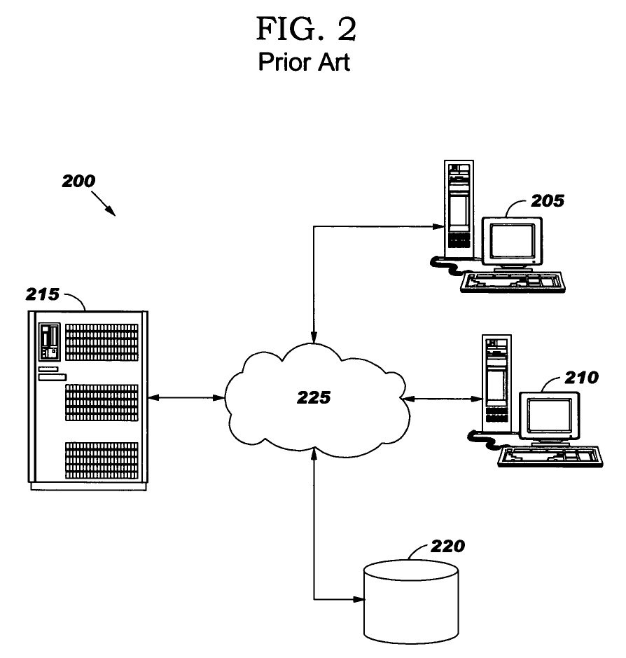

Additionally, the TreeMap Program is described below with reference to an exemplary network of hardware devices, as depicted in FIG. 2. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 200 has only a limited number of nodes, including workstation computer 205, workstation computer 210, server computer 215, and persistent storage 220. Network connection 225 comprises all hardware, software, and communications media necessary to enable communication between network nodes 205-220. Unless otherwise indicated in context below, all network nodes use publicly available protocols or messaging services to communicate with each other through network connection 225.

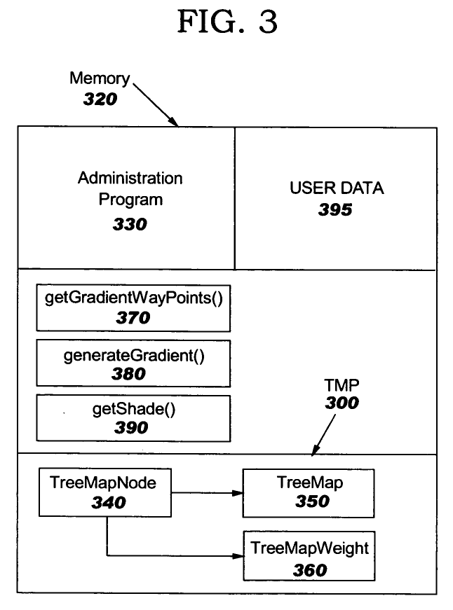

TreeMap Program (TMP) 300 typically is stored in a memory, represented schematically as memory 320 in FIG. 3. In the preferred embodiment, TMP 300 is implemented as a JAVA program comprising a base class, designated as TreeMapNode 340 in FIG. 3, and two classes that extend TreeMapNode 340, namely TreeMap 350 and TreeMapWeight 360. TreeMap 350 represents non-leaf nodes in a hierarchy, while TreeMap 360 represents leaf nodes. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 3 is included merely as a descriptive expedient and does not necessarily reflect any particular physical embodiment of memory 320. As depicted in FIG. 3, though, memory 320 may include additional data and programs. Of particular import to TMP 300, memory 320 may include administration program 330, getGradientWayPoints function 370, generateGradient function 380, getshade function 390, and user data 395, with which TMP 300 interacts.

In such an embodiment, administration program 330 provides an interface through which a system administrator can configure and monitor network nodes. In particular, administration program 330 allows a system administrator to monitor the performance of any network node. Typically, administration program 330 collects data such as CPU usage, goal attainment, name, and number of deployed applications for each network node. For illustrative purposes, the following discussion assumes that administration program 330 directly measures the performance of network nodes, but as noted above, such a function easily could be delegated to a more specialized programming unit.

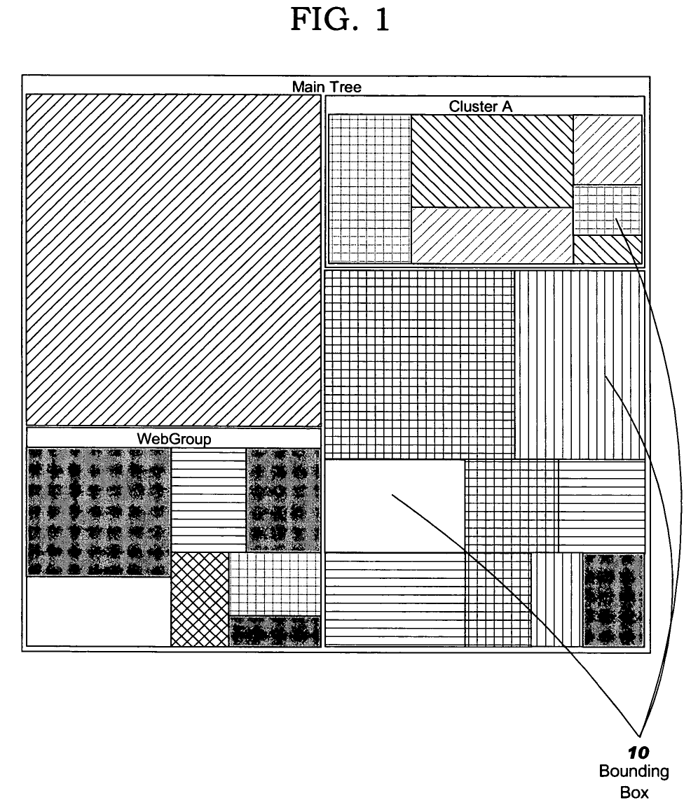

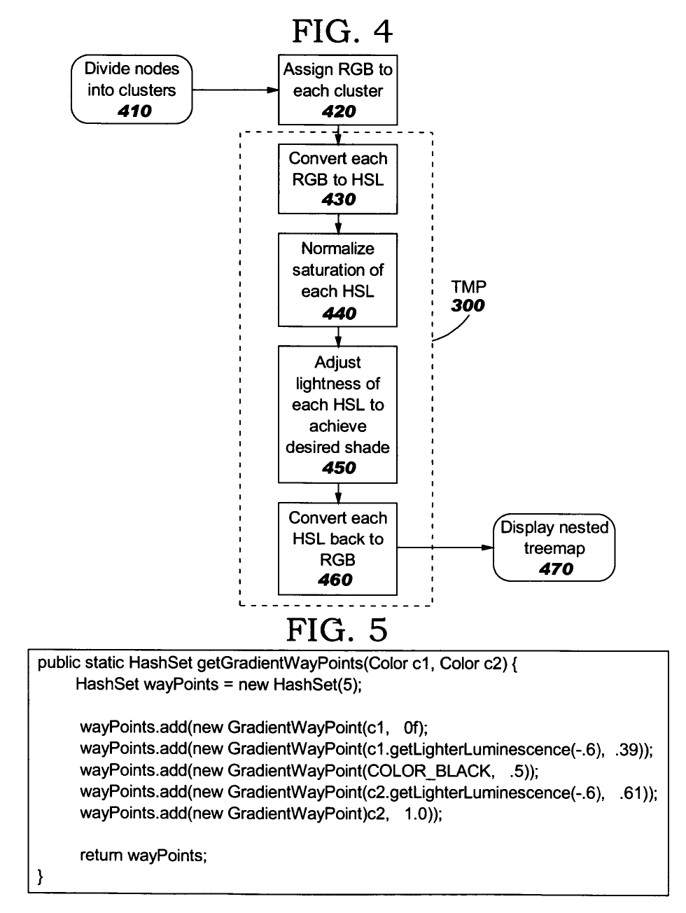

FIG. 4 illustrates the inventive process when implemented as TMP 300, in conjunction with administration program 330. Administration program 330 allows a system administrator to divide the network nodes into clusters (410), and store such a division in memory as user data 395. Such a division may be arbitrary, but to realize the full benefits of the inventive process each cluster should include logically related nodes. Thus, as used herein, a “cluster” is any number of nodes that are treated collectively as a unit for purposes of displaying data in a treemap. For example, one cluster might include all web server nodes, as indicated in FIG. 1 by the “WebGroup” cluster, while another includes all file server nodes. Through administration program 330, the system administrator also designates which node properties a treemap should display, such as CPU usage and the number of applications deployed, and which property the treemap should display as a primary weight and a secondary weight. As used herein, the “primary weight” refers to the property that a treemap displays as a bounding box having an area that is proportional to the property, and the “secondary weight” refers to the property that the treemap displays as a color gradient representative of the property.

Administration program 330 also allows the system administrator to choose a color for each cluster of nodes (420), which is stored in memory 320 as user data 395. In one embodiment, the system administrator designates a single “base” color, which identifies the “middle” of a desired range of color gradients for a node cluster. White and black then become the extremes of the range. Alternatively, the system administrator chooses a “low” color and a “high” color, which represent the extremes of the desired color gradient for each cluster. In two-color embodiment, black is the middle color. In either embodiment, though, the system administrator or administration program 330 identifies each color as a triplet in a Red, Green, Blue (RGB) color model. As used herein, an RGB color model is any additive color model in which red, green, and blue light are combined in various ways to create other colors. In practice, every color in an RGB color model is identified as a triplet of numbers. Each value in an RGB triplet is a number between 0 and 255, representing the intensity of the primary red, green, and blue colors, respectively, in a given color. Although many color models are available to choose from, the RGB color model is a convenient and commonly used model with which most administrators should be familiar.

When a system administrator or other user invokes TMP 300 from administration program 330, administration program 330 creates an instance (“instantiates”) of TreeMapNode 340 for each node cluster. Each instance of TreeMapNode 340 then loads the preferred color for its node from user data 395, instantiates TreeMap 350 for each internal node, and TreeMapWeight 360 for each leaf node.

Although the RGB color model is familiar to administrators, color gradients are more readily manipulated when modeled as a combination of Hue, Saturation, and Lightness (HSL). Thus, in one embodiment, TMP 300 converts each RGB triplet to an equivalent HSL triplet for easier manipulation (430). As used herein, “hue” refers to a particular color within the visible spectrum, as defined by its dominant wavelength. See, generally, Color Theory, httn://www.colorcube.com/articles/theory/theory.htm (2000) (last visited Oct. 12, 2004) (incorporated herein by reference). In short, hue distinguishes red from green from blue. “Lightness” (also sometimes referred to as “luminance” or “luminescence”) indicates the intensity of light per unit area of its source. See id. In general, “saturation” is the intensity of a color at any given lightness. Id. In an HSL color model, saturation is defined mathematically as the difference between the maximum of the equivalent RGB values and the minimum of the equivalent RGB values, or
saturation=max(R,G,B)−min(R,G,B).
See, e.g., TheFreeDictionary.com, http://encyclopedia.thefreedictionary.com/HLS%20color%20space (last visited Oct. 12, 2004) (incorporated herein by reference). Similarly, lightness is defined as the average of the sum of the minimum and maximum, or
lightness=(max(R,G,B)+min(R,G,B))/2
Id. Algorithms for converting RGB triples to HSL triples and vice versa are common and, thus, not discussed in detail here. See, e.g., The World Wide Web Consortium, CSS3 Color Module: W3C Candidate Recommendation (Tantek Celic & Chris Lilley eds., May 14, 2003), http://www.w3.org/TR/css3-color/#hsl-color (last visited Oct. 12, 2004) (incorporated herein by reference).

After converting each RGB triple to an equivalent HSL triplet, TMP 300 then adjusts each saturation value to approximately 0.5 (or 50%), which provides a normalized, softer look to the color (440). Next, administration program 330 generates a dataset comprised of the network node properties specified by the system administrator, grouped hierarchically by cluster. TMP 300 then determines the maximum and minimum values of each property in the dataset, and divides the secondary weight range into bins. As used herein, the term “bin” refers to any discrete interval within the range of secondary weight values of any given cluster. In the embodiment described herein, each bin represents a percentage interval (e.g. 20%-30%) of the secondary weight range for a cluster of nodes. The system administrator may specify the number of bins through administrator program 330, and save the number as user data 395.

TMP 300 then generates color gradients at “waypoints” for the secondary weight range, so that the middle color is limited to a reasonable range. The function getGradientWayPoints 370 in FIG. 5 illustrates one JAVA implementation of the waypoint generation, in which the system administrator designates a low color and a high color. As FIG. 5 illustrates, getGradientWayPoints 370 creates waypoints by adjusting the lightness component of both the low color (“c1”) and the high color (“c2”) to create a gradient of each color that is closer to the middle color (which is black by default). Each waypoint color is then assigned to a specific percentage of the secondary weight range. In general, the waypoint percentages approximately represent the 39% and 61% lines of the secondary weight range.

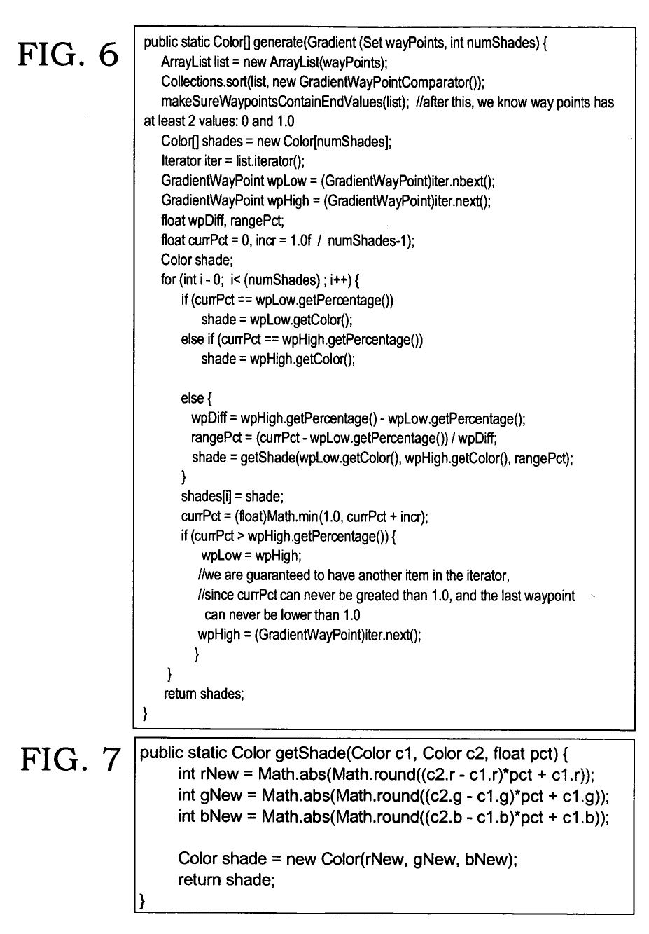

After generating the color gradient for each waypoint, TMP 300 generates an array of color gradients for each remaining bin in the secondary weight range (450). The function generateGradient 380 in FIG. 6 illustrates one JAVA implementation of the gradient generation process. As FIG. 6 illustrates, generateGradient 380 accepts two arguments. The first, “Set wayPoints,” is a list of waypoints and associated color gradients, such as those generated by getGradientWayPoints 370. The second argument, “int numShades” represents the number of color gradients to generate, which also is the number of secondary weight bins that the system administrator specifies in user data 395. Function generateGradient 380 iterates through each bin, determining the difference between the waypoints surrounding each bin (“wpDiff”) and the proportional distance between the lower waypoint and the bin (“rangePct”), and then generating a gradient for each bin (“shade”). The function getShade 390 in FIG. 7 illustrates one JAVA implementation generating a gradient that is proportional to two bounding colors. As FIG. 7 illustrates, getShade 390 accepts three arguments. The first two arguments (“Color c1” and “Color c2”) represent the bounding colors, while the third argument (“float pct”) represents the desired adjustment as a percentage. As FIG. 7 illustrates, getShade 390 essentially just averages the RGB components of the two bounding colors. Alternatively, getShade 390 could directly adjust the lightness component of either bounding color to generate the desired gradient.

Finally, TMP 300 generates an index into the array of gradients that associates the secondary weight of each node with a color gradient in the array, calculates the appropriate size of bounding box to represent the primary weight of each node (460), and renders the treemap for the generated dataset (470).

A preferred form of the invention has been shown in the drawings and described above, but variant in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A process for displaying hierarchical information in a finite display space, the hierarchical information comprising a plurality of nodes divided into at least two clusters, each cluster having a distinct color comprising a RGB triplet, and each node having a primary weight and a secondary weight; the process comprising:
converting each RGB triplet to an equivalent HSL triplet, each equivalent HSL triplet comprising
a hue component,
a saturation component, and
a lightness component;
adjusting the lightness component to generate a discrete color gradient for each secondary weight of each node in each cluster;
converting each discrete color gradient to an equivalent RGB triplet; and
drawing a treemap on an output device so that the treemap comprises
a nested treemap for each cluster, the nested treemap having the cluster's distinct color and comprising a bounding box for each node in the cluster, each bounding box having an area proportional to the primary weight of the node and a discrete color gradient of the equivalent RGB triplet that represents the secondary weight of the node.

2. The process of claim 1 further comprising the step of:
after converting each RGB triplet to an equivalent HSL triplet, normalizing the saturation component.

3. The process of claim 2, wherein the saturation component is normalized to approximately 50%.

4. A data processing machine for displaying hierarchical information in a finite display space, the hierarchical information comprising a plurality of nodes divided into at least two clusters, each cluster having a distinct color comprising an RGB triplet, and each node having a primary weight and a secondary weight; the data processing machine comprising:
a processor;
a memory;
an output device; and
a program in the memory operable to cause the processor to
convert each RGB triplet to an equivalent HSL triplet, each equivalent HSL triplet comprising
a hue component,
a saturation component, and
a lightness component,
adjust the lightness component to generate a discrete color gradient to represent a discrete value of the secondary weight of each node in each cluster,
convert each discrete color gradient to an equivalent RGB triplet, and
draw a treemap on the output device so that the treemap comprises
a nested treemap for each cluster, the nested treemap having the cluster's distinct color and comprising a bounding box for each node in the cluster, each bounding box having an area proportional to the primary weight of the node and a discrete color gradient that represents the secondary weight of the node.

5. The data processing machine of claim 4, wherein the program in the memory is further operable to cause the processor to:
normalize the saturation component after converting each RGB triplet to an equivalent HSL triplet.

6. The data processing machine of claim 5, wherein the program causes the processor to normalize the saturation component to approximately 50%.

7. A computer program encoded in a computer-readable memory operable to cause a computer to render a treemap of hierarchical information, the hierarchical information comprising a plurality of nodes divided into at least two clusters, each cluster having a distinct color comprising an RGB triplet, and each node having a primary property weight and a secondary weight; the computer program comprising:
instructions for causing the computer to convert each RGB triplet into an equivalent HSL triplet, each equivalent HSL triplet comprising
a hue component,
a saturation component, and
a lightness component;
instructions for causing the computer to adjust the lightness component to generate a discrete color gradient to represent the secondary weight of each node in each cluster;
instructions for causing the computer to convert each discrete color gradient to an equivalent RGB triplet; and
instructions for causing the computer to render the treemap on an output device so that the treemap comprises
a nested treemap for each cluster, the nested treemap having the cluster's distinct color and comprising a bounding box for each node in the cluster, each bounding box having an area proportional to the primary weight of the node and a discrete color gradient that represents the secondary weight of the node.

8. The computer program of claim 7 further comprising instructions for causing the computer to normalize the saturation component after converting each RGB triplet to an equivalent HSL triplet.

9. The computer program of claim 8, wherein the instructions for causing the computer to normalize the saturation component are instructions for causing the computer to normalize the saturation component to approximately 50%.

10. A computer-implemented process for displaying hierarchical information in a finite display space, the hierarchical information comprising a plurality of nodes divided into at least two clusters, each cluster having a base color, and each node having a primary weight and a secondary weight; the process comprising the steps of:
drawing a primary treemap;
for each cluster,
steps for dividing the range of the cluster's secondary weight into bins, and for each bin in the range,
steps for adjusting the base color to create a distinguishing gradient of the base color, and
steps for assigning the distinguishing gradient to the bin; and
for each cluster, drawing a nested treemap in the primary treemap, the nested treemap having the cluster's base color, and
for each node in the cluster,
steps for assigning the node's secondary weight to a bin representing the range into which the node's secondary weight falls, and
steps for drawing a bounding box in the nested treemap, the bounding box having an area proportional to the node's primary weight and having the distinguishing gradient of the base color assigned to the bin.

11. The process of claim 10 wherein:
each bin represents a percentage interval of the secondary weight range of the cluster;
the distinguished gradient assigned to the bin representing a percentage interval that includes the median secondary weight is equivalent to the base color;
the distinguished gradient assigned to each bin representing a percentage interval that is less than the median secondary weight has the same hue as the base color and a lightness component proportional to the difference between the median secondary weight and the minimum secondary weight; and
the distinguished gradient assigned to each bin representing a percentage interval that is greater than the median secondary weight has the same hue as the base color and a lightness component proportional to the difference between the maximum secondary weight and the median secondary weight.

12. The process of claim 10 wherein the base color of each cluster is black, each cluster further has a low color and a high color, each cluster further has a first waypoint value and a second waypoint value, the first waypoint value representing a discrete percentage of the difference between the minimum secondary weight of the cluster and the median secondary weight of the cluster, the second waypoint value representing a discrete percentage of the difference between the median secondary weight of the cluster and the maximum secondary weight of the cluster, each bin represents a percentage interval of the secondary weight range of the cluster, and the steps for adjusting the base color to create a distinguishing gradient of the base color for each bin in a cluster further comprise:
steps for generating a first waypoint color having the same hue as the base color and a lightness component proportional to the difference between the minimum secondary weight of the cluster and the median secondary weight of the cluster;
steps for generating a second waypoint color having the same hue as the base color and a lightness component that is proportional to the difference between the median secondary weight of the cluster and the maximum secondary weight of the cluster; and wherein
the distinguished gradient assigned to each bin representing a percentage interval that is less than the first waypoint value has the same hue as the low color and a lightness component proportional to the difference between the minimum secondary weight and the first waypoint value;
the distinguished gradient assigned to each bin representing a percentage interval that is greater than the first waypoint value but less than the median secondary weight value has the same hue as the low color and a lightness component proportional to the difference between the median secondary weight and the first waypoint value;
the distinguished gradient assigned to each bin representing a percentage interval that is greater than the median secondary weight but less than the second waypoint value has the same hue as the high color and a lightness component proportional to the difference between the second waypoint value and the median secondary weight; and
the distinguished gradient assigned to each bin representing a percentage interval that is greater than the second waypoint value has the same hue as the high color and a lightness component proportional to the difference between the maximum secondary weight and the second waypoint value.

13. The process of claim 12 wherein the first waypoint value is approximately 39% of the secondary weight range and the second waypoint value is approximately 61% of the secondary weight range.

14. A data processing machine for displaying hierarchical information in a finite display space, the hierarchical information comprising a plurality of nodes divided into at least two clusters, each cluster having a base color, and each node having a primary weight and a secondary weight; the data processing machine comprising:
a processor;
a memory;
an output device; and
a computer program in the memory, the computer program comprising means for causing the processor to
draw a primary treemap on the output device,
for each cluster,
divide the range of the cluster's secondary weight into bins, and
for each bin in the range,
adjust the base color to create a distinguishing gradient of the base color, and
assign the distinguishing gradient to the bin; and
for each cluster, draw a nested treemap in the primary treemap, the nested treemap having the cluster's base color, and
for each node in the cluster,
assign the node's secondary weight to a bin representing the range into which the node's secondary weight falls, and
draw a bounding box in the nested treemap, the bounding box having an area proportional to the node's primary weight and having the distinguishing gradient of the base color assigned to the bin.

15. The data processing machine of claim 14 wherein:
each bin represents a percentage interval of the secondary weight range of the cluster;
the distinguished gradient assigned to the bin representing a percentage interval that includes
the median secondary weight is equivalent to the base color;
the distinguished gradient assigned to each bin representing a percentage interval that is less than the median secondary weight has the same hue as the base color and a lightness component proportional to the difference between the median secondary weight and the minimum secondary weight; and
the distinguished gradient assigned to each bin representing a percentage interval that is greater than the median secondary weight has the same hue as the base color and a lightness component proportional to the difference between the maximum secondary weight and the median secondary weight.

16. The data processing machine of claim 14 wherein the base color of each cluster is black, each cluster further has a low color and a high color, each cluster further has a first waypoint value and a second waypoint value, the first waypoint value representing a discrete percentage of the difference between the minimum secondary weight of the cluster and the median secondary weight of the cluster, the second waypoint value representing a discrete percentage of the difference between the median secondary weight of the cluster and the maximum secondary weight of the cluster, each bin represents a percentage interval of the secondary weight range of the cluster, and the means for adjusting the base color to create a distinguishing gradient of the base color for each bin in a cluster further comprise means for causing the processor to:
generate a first waypoint color having the same hue as the base color and a lightness component proportional to the difference between the minimum secondary weight of the cluster and the median secondary weight of the cluster;
generate a second waypoint color having the same hue as the base color and a lightness component that is proportional to the difference between the median secondary weight of the cluster and the maximum secondary weight of the cluster; and wherein
the distinguished gradient assigned to each bin representing a percentage interval that is less than the first waypoint value has the same hue as the low color and a lightness component proportional to the difference between the minimum secondary weight and the first waypoint value;
the distinguished gradient assigned to each bin representing a percentage interval that is greater than the first waypoint value but less than the median secondary weight value has the same hue as the low color and a lightness component proportional to the difference between the median secondary weight and the first waypoint value;
the distinguished gradient assigned to each bin representing a percentage interval that is greater than the median secondary weight but less than the second waypoint value has the same hue as the high color and a lightness component proportional to the difference between the second waypoint value and the median secondary weight; and
the distinguished gradient assigned to each bin representing a percentage interval that is greater than the second waypoint value has the same hue as the high color and a lightness component proportional to the difference between the maximum secondary weight and the second waypoint value.

17. The data processing machine of claim 16 wherein the first waypoint value is approximately 39% of the secondary weight range and the second waypoint value is approximately 61% of the secondary weight range.

18. A computer program encoded in a computer-readable memory operable to cause a computer to displaying hierarchical information in a finite display space, the hierarchical information comprising a plurality of nodes divided into at least two clusters, each cluster having a base color, and each node having a primary weight and a secondary weight; the computer program comprising:
means for drawing a primary treemap;
for each cluster,
means for dividing the range of the cluster's secondary weight into bins, and
for each bin in the range,
means for adjusting the base color to create a distinguishing gradient of the base color, and
means for assigning the distinguishing gradient to the bin; and
for each cluster, means for drawing a nested treemap in the primary treemap, the nested treemap having the cluster's base color, and
for each node in the cluster,
means for assigning the node's secondary weight to a bin representing the range into which the node's secondary weight falls, and
means for drawing a bounding box in the nested treemap, the bounding box having an area proportional to the node's primary weight and having the distinguishing gradient of the base color assigned to the bin.

19. The computer program of claim 18 wherein:
each bin represents a percentage interval of the secondary weight range of the cluster;
the distinguished gradient assigned to the bin representing a percentage interval that includes the median secondary weight is equivalent to the base color;
the distinguished gradient assigned to each bin representing a percentage interval that is less than the median secondary weight has the same hue as the base color and a lightness component proportional to the difference between the median secondary weight and the minimum secondary weight; and
the distinguished gradient assigned to each bin representing a percentage interval that is greater than the median secondary weight has the same hue as the base color and a lightness component proportional to the difference between the maximum secondary weight and the median secondary weight.

20. The computer program of claim 18 wherein the base color of each cluster is black, each cluster further has a low color and a high color, each cluster further has a first waypoint value and a second waypoint value, the first waypoint value representing a discrete percentage of the difference between the minimum secondary weight of the cluster and the median secondary weight of the cluster, the second waypoint value representing a discrete percentage of the difference between the median secondary weight of the cluster and the maximum secondary weight of the cluster, each bin represents a percentage interval of the secondary weight range of the cluster, and the means for adjusting the base color to create a distinguishing gradient of the base color for each bin in a cluster further comprise:
means for generating a first waypoint color having the same hue as the base color and a lightness component proportional to the difference between the minimum secondary weight of the cluster and the median secondary weight of the cluster;
means for generating a second waypoint color having the same hue as the base color and a lightness component that is proportional to the difference between the median secondary weight of the cluster and the maximum secondary weight of the cluster; and wherein
the distinguished gradient assigned to each bin representing a percentage interval that is less than the first waypoint value has the same hue as the low color and a lightness component proportional to the difference between the minimum secondary weight and the first waypoint value;
the distinguished gradient assigned to each bin representing a percentage interval that is greater than the first waypoint value but less than the median secondary weight value has the same hue as the low color and a lightness component proportional to the difference between the median secondary weight and the first waypoint value;
the distinguished gradient assigned to each bin representing a percentage interval that is greater than the median secondary weight but less than the second waypoint value has the same hue as the high color and a lightness component proportional to the difference between the second waypoint value and the median secondary weight; and
the distinguished gradient assigned to each bin representing a percentage interval that is greater than the second waypoint value has the same hue as the high color and a lightness component proportional to the difference between the maximum secondary weight and the second waypoint value.

21. The computer program of claim 20 wherein the first waypoint value is approximately 39% of the secondary weight range and the second waypoint value is approximately 61% of the secondary weight range.
